(19) United States
(12) Patent Application Publication
(10) Pub. No.: US 2002/0099753 A1
(43) Pub. Date: Jul. 25, 2002

(54) System and method for concurrently supporting multiple independent virtual machines

(76) Inventors: David S. Hardin, Cedar Rapids, IA (US); Danh Le Ngoc, Saratoga, CA (US); Allen P. Mass, Lisbon, IA (US); Michael H. Masters, Cedar Rapids, IA (US); Nick M. Mykris, Cedar Rapids, IA (US)

Correspondence Address: SIMMONS, PERRINE, ALBRIGHT & ELLWOOD, P.L.C., THIRD FLOOR TOWER PLACE, 22 SOUTH LINN STREET, IOWA CITY, IA, 52240, US

(21) Appl. No.: 09/681,136

(22) Filed: Jan. 20, 2001

(51) Int. Cl. G06F 17/00

(52) U.S. Cl. 709/1

(57) ABSTRACT

An improved system for concurrently running multiple virtual machines on a single processor. Each virtual machine being activated only during an assigned time slice or partition so as to isolate each of the concurrently running virtual machines from each other. The system having a power management mode and/or a partition reassignment mode. The power management feature placing the processor into a reduced power mode when a particular virtual machine has nothing to do during its assigned partition. In one embodiment, when an application has not been loaded into a given virtual machine, the processor is placed into a reduced power mode during the partition assigned to the given virtual machine. In one embodiment, the virtual machine is a JAVA Virtual Machine.

### BACKGROUND OF THE INVENTION

It is desirable in various environments and applications to utilize a computer system concurrently running multiple independent virtual machines. For example, such a system can be useful in a real-time application wherein multiple JAVA Virtual Machines (JVM) are run on a single processor. Computing systems employing virtual machines permit code to be written for a wide variety of computing systems. Code can then be written independently of host hardware or operating system considerations. Systems using virtual machines also reap security and efficiency benefits.

The multiple, concurrent JVM technique enables complete isolation between resources using different JVMs. By way of further example, the multiple JVM technique permits a particular JVM to be customized to better serve the resources that have been assigned to it. In addition, a multiple JVM system can be efficiently ported to a multi-processor system from a single, shared processor system.

There exists a need for further refinements and improvements to the multiple virtual machine system. More particularly, there exists a need for a power management scheme for the multiple virtual machine system. There also exists a need for a partition reassignment scheme. These needs are addressed and fulfilled by the detailed description provided below.

### SUMMARY OF THE INVENTION

The present invention involves an improved system for concurrently running multiple virtual machines on a single processor. The improved system of the present invention includes power management and virtual machine scheduling features. The power management feature can improve efficiency and conserve energy.

In a system concurrently running multiple virtual machines, each virtual machine is activated only during its assigned time slice or partition. In this manner, each independent virtual machine is isolated and insulated from each of the other concurrently running virtual machines. When the power management feature is implemented in such a system, the processor can be placed into a low power or sleep mode when a particular virtual machine has nothing to do during its assigned partition. For example, when an application has not been loaded into a given virtual machine or the machine is otherwise idle, the processor is placed in the low power or sleep mode for the remainder, or the entirety, of the partition assigned to that virtual machine. In another embodiment, when the scheduled virtual machine is determined to be inactive, a different virtual machine is activated in its place. In one embodiment, the virtual machine is a JAVA Virtual Machine. It will be appreciated, however, the invention can also be used with a wide variety of virtual machines.

### BRIEF DESCRIPTION OF THE DRAWINGS

The invention may be more fully understood by reading the following description of the invention, in conjunction with the appended drawings wherein:

FIG. 1 depicts the relevant data structures of an embodiment of the invention involving multiple, concurrent virtual machines.

FIG. 2 is a flowchart depicting the steps involved in implementing an embodiment wherein a lower power mode is entered when the scheduled virtual machine of a multiple virtual machine system is determined to be idle.

FIG. 3 is a flowchart depicting the steps involved in implementing an embodiment wherein a subsequent virtual machine is activated when the next scheduled virtual machine of a multiple virtual machine system is determined to be idle.

FIGS. 4A and 4B provide a detailed depiction of the relevant data structures of an embodiment of the invention including multiple, concurrent JAVA virtual machines.

FIG. 5 depicts three virtual machine schedules used with one embodiment of the present invention.

FIG. 6 depicts the error codes used in conjunction with one embodiment of the present invention.

FIG. 7 depicts the structure and fields of a list of initialized data blocks used in one embodiment of the present invention.

### DETAILED DESCRIPTION

Several applications exist wherein it is desirable to concurrently run multiple virtual machines on a single processor. For example, some of these applications involve real-time embedded processor systems. Some other important applications involve customization of some or all of the multiple virtual machines in order to better serve the resources assigned thereto. Yet other applications have a need for complete isolation between resources using different virtual machines. Still other applications require two or more of the above-described benefits. Further, multiple virtual machine systems can have the added advantage of being efficiently ported to a multi-processor system from a single, shared processor system.

A multiple virtual machine system, including related applications, advantages and embodiments, is described in detail in U.S. patent application Ser. No. 09/056,126, filed Apr. 6, 1998, entitled “Real Time Processor Capable of Concurrently Running Multiple Independent JAVA Machines,” to Gee et al. U.S. patent application Ser. No. 09/056,126, filed Apr. 6, 1998, is hereby incorporated herein in its entirety, including all drawings and any appendices, by this reference. In addition, one type of virtual machine, the JAVA Virtual Machine, is described in detail in “The Java Virtual Machine Specification,” Tim Lindholm and Frank Yellin, Addison-Wesley, Inc., (2nd ed., 1999). “The Java Virtual Machine Specification,” Tim Lindholm and Frank Yellin, Addison-Wesley, Inc., (2nd ed., 1999) (ISBN 0-201-43294-3), is hereby incorporated herein in its entirety by this reference.

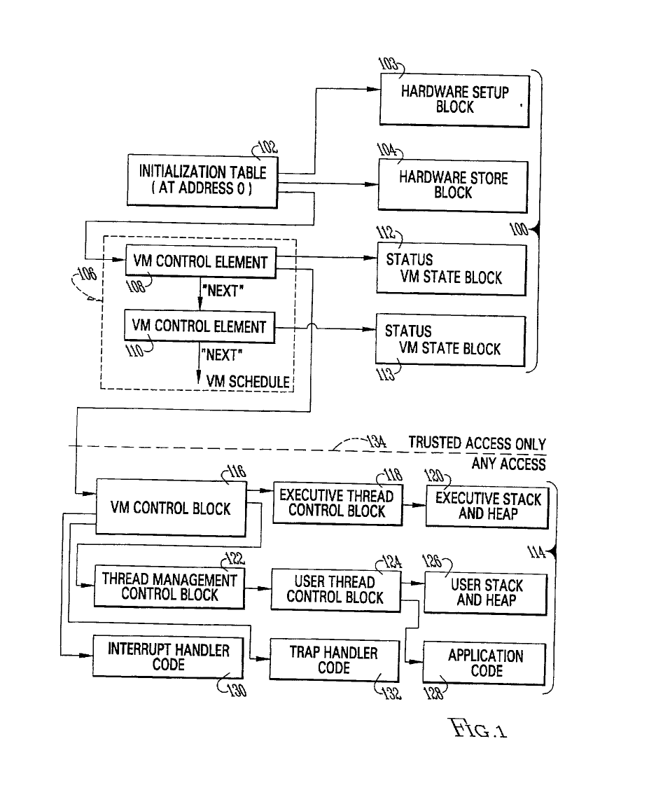

FIG. 1 depicts the general structure of a system including multiple, concurrent virtual machines. The upper portion of FIG. 1 depicts the multiple virtual machine environment 100. The multiple virtual machine environment 100 includes an initialization table 102 and its associated hardware store block 104 and virtual machine schedule 106. The virtual machine schedule 106 includes a plurality of virtual machine control elements 108, 110, two of which are depicted in FIG. 1. Each virtual machine control element is associated with a virtual machine state block 112, 113 and a logical execution environment 114. Although each virtual machine control element is associated with a distinct logical execution environment, only the logical execution environment 114 associated with the first virtual machine control element 108 is depicted in FIG. 1.

The initialization table 102 is a root data structure used to start execution. The elements of the initialization table 102 can include pointers to items such as processor specific setup (Hardware Setup Block 103) and data storage locations (hardware store block 104), system level initialization data structures and various restart and power down lists. An example of one embodiment of an initialization table is presented in greater detail below.

The virtual machine schedule 106 can be a linked list of the various scheduled virtual machine control elements. The virtual machine schedule 106 can be cyclical such that the schedule is repeated one or more times. When desired, the system can have two or more different virtual machine schedules, each identified in the initialization table 102, with each virtual machine schedule tailored to meet a specific need or circumstance. Further, one or more of the virtual machine control elements of a given virtual machine schedule can be JAVA virtual machine control elements. In addition, although two virtual machine control elements 108, 110 are shown in the virtual machine schedule of FIG. 1, it will be appreciated that virtual machine schedules can be tailored to include the number of virtual machine control elements deemed appropriate to meet the demands of the application at hand.

The virtual machine state blocks 112, 113 store state information upon suspension of a partition. The fields of a virtual machine state block can include data and status codes as well as pointers to various data structures and locations. Activation of a suspended partition is accomplished by referencing the information identified by the virtual machine state block related to the scheduled virtual machine control element.

The lower portion of FIG. 1 depicts the logical execution environment 114 associated with one of the virtual machine control elements. The logical execution environment 114 includes a virtual machine control block 116 associated with an executive thread control block 118 and an executive stack and heap 120. The virtual machine control block 116 is further associated with a thread management control block 122. The thread management control block 122 is associated with a user thread control block 124 that is in turn associated with a user stack and heap 126 and the application code 128. The virtual machine control block 116 is also associated with interrupt handler code 130 and trap handler code 132.

Each virtual machine control element of the virtual machine schedule 106 is associated with its own logical execution environment. When, for example, a given virtual machine control element is a JAVA virtual machine control element, the associated virtual machine control block will be a JAVA virtual machine control block. As noted, however, other types of virtual machines can be used with the present invention. An embodiment of the logical execution environment 114 is described in greater detail in incorporated patent application Ser. No. 09/056,126, filed Apr. 6, 1998 (see, for example, the discussion related to FIG. 13 of the incorporated application).

In addition to the isolated memory space for each virtual machine in a system, there exists a system-wide memory space reserved for privileged data structures. The dashed line 134 shows the boundary of the “trusted access only” space (above the dashed line 134) and the “any access” space (below the dashed line 134). Typically, only the executive code is allowed to access memory in the trusted access space.

The executive code, as described in the incorporated patent application, runs during the interstices between each partition. The executive code can, for example, be microcoded into the processor or can be a separate software routine (such as the JVM0 of FIG. 14 of the incorporated patent application). The privileged data structures enjoying “trusted access only” status include the initialization table, the virtual machine schedule or schedules represented by the virtual machine control elements, the virtual machine state block associated with each virtual machine control element, memory protection configuration parameters and processor specific data blocks.

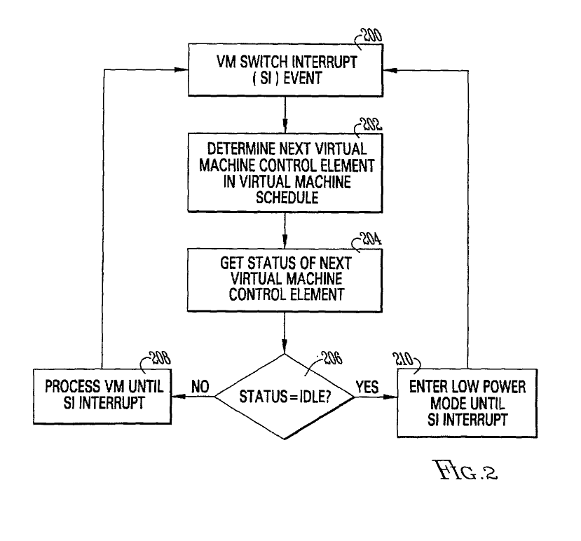

FIG. 2 is a flowchart depicting steps involved in implementing an embodiment wherein a lower power mode is entered when a scheduled virtual machine of a multiple virtual machine system is determined to be idle. The process is initiated upon the generation of a virtual machine switch interrupt 200. The switch interrupt event 200 signals the end of the currently active virtual machine's partition. After the virtual machine switch interrupt event 200, the next virtual machine control element (for example, 108, 110, FIG. 1) to be activated in the virtual machine schedule 106, FIG. 1, is determined 202. The identity of the next virtual machine control element is obtained from the virtual machine schedule.

Status information on the next virtual machine control element to be activated is then obtained 204. In one embodiment, the status information is held (or identified) by the virtual machine state block associated with the next virtual machine control element. The status information is then read 206. If the status information shows that the next virtual machine to be activated is not idle or has tasks to perform, then that virtual machine is activated 208 until the end of its associated partition is signaled by a virtual machine switch interrupt event 200. If, however, the status information shows that the next virtual machine to be activated is idle or has no tasks to perform, then a reduced power mode (such as a low power, suspend or sleep mode) is entered 210 until the end of the partition associated with the idle virtual machine is signaled by a virtual machine switch interrupt event 200. In one embodiment, one or more of the virtual machines discussed in relation to FIG. 2 are JAVA virtual machines (for example, JAVA virtual machines such as are described in the incorporated reference “The Java Virtual Machine Specification”).

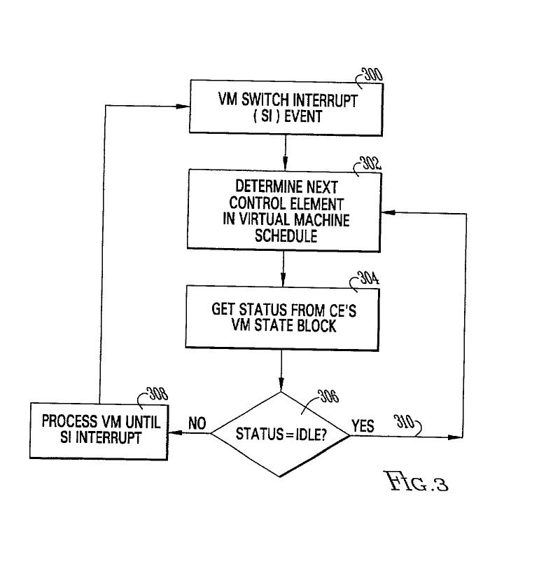

FIG. 3 is a flowchart depicting the steps involved in implementing an embodiment wherein a subsequent virtual machine is activated when the next scheduled virtual machine of a multiple virtual machine system is determined to be idle. The process is initiated upon the generation of a virtual machine switch interrupt 300. The switch interrupt event 300 signals the end of the currently active virtual machine's partition. After the virtual machine switch interrupt event 300, the next virtual machine control element (for example, 108, 110, FIG. 1) to be activated in the virtual machine schedule 106, FIG. 1, is determined 302. The identity of the next virtual machine control element is obtained from the virtual machine schedule.

Status information on the next virtual machine control element to be activated is then obtained 304. In one embodiment, the status information is held (or identified) by the virtual machine state block associated with the next virtual machine control element. The status information of the next scheduled virtual machine is then read 306. If the status information shows that the next virtual machine to be activated is not idle or has tasks to perform, then that virtual machine is activated 308 until the end of its associated partition is signaled by a virtual machine switch interrupt event 300.

If, however, the status information shows that the next virtual machine to be activated is idle or has no tasks to perform 310, then the next scheduled virtual machine control element following the idle virtual machine is determined 302 and its status information is read. The non-idle virtual machine is then activated for the duration of the partition. If desired, this process can be repeated until status information indicating a non-idle virtual machine is read 306. Alternatively, the search for a non-idle virtual machine can be repeated for a finite number of status reads, for a pre-determined time interval, or until the end of the partition is signaled by a virtual machine switch interrupt. In yet another related embodiment, a lower power mode can be entered if a non-idle virtual machine is not identified during a defined time interval or within a specified number of iterations of the determining 302 and reading 306 loop. In one embodiment, one or more of the virtual machines discussed in relation to FIG. 3 are JAVA virtual machines (for example, JAVA virtual machines such as are described in the incorporated reference “The Java Virtual Machine Specification”).

The following paragraphs will describe in detail one of the systems with which the present related group of inventions can be used. The following material is presented to provide an example of an application of the present invention and not to limit the scope of the invention in any manner. It will be appreciated that the present invention can be used with many different types of systems and environments and that the following description presents one such operational environment.

The following embodiment includes an embedded, 32-bit, low-power JAVA microprocessor such as the aJ-80 or aJ-100 microprocessor marketed by aJile Systems, Inc. Using the strict time and space partitioning of this type of processor, multiple virtual machines can execute concurrently. Thus, the following described data structures and execution can support multiple, concurrent virtual machines on a single processor.

One motivation for implementing multiple virtual machines is to allow multiple applications to execute while isolating the resources in one application from the resources in another application. Both time and space partitioning should be addressed to provide deterministic execution of each application independent of the other virtual machines in the system. An application within one virtual machine is thereby prevented from adversely affecting another application within a different virtual machine through faulty operation, a direct attack or a depletion of resources.

Another motivation for using multiple virtual machines is to enable the implementation of different policies for different applications. For example, the range of priorities in one virtual machine may be higher than that for another virtual machine. Garbage collection strategies may differ, including even the existence of a garbage collector. Different limitations may also apply to different virtual machines such as the amount of memory, number of threads and processing time allocated. Yet another motivation for virtual machine isolation is that it allows separate applications to be developed and tested independently. These applications can then be integrated onto a single processor or reconfigured to multiple distributed processors as throughput requirements increase.

In the present embodiment, each virtual machine may be created either statically or dynamically. A statically created virtual machine is initialized with the output of a static linker; it may be augmented with dynamically loaded classes. A dynamically created virtual machine is initialized by a dynamic loader. The execution sequence within the virtual machine includes: 1) the initialized data block copies, 2) execution of the executive software, and optionally followed by 3) activation of the user software.

In this embodiment the executive is microcoded. Typically, only the microcoded executive is allowed to access memory in the “trusted access” space. The privileged data structures in this embodiment include the initialization table, three schedules represented by doubly-linked lists of virtual machine control elements, the virtual machine state block associated with each virtual machine, memory protection configuration parameters and processor specific data blocks.

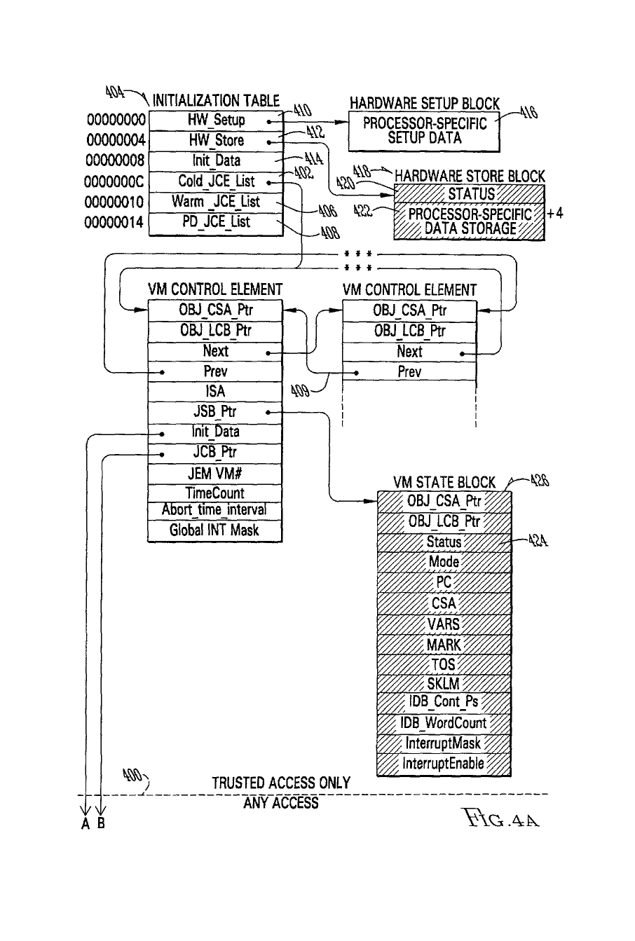

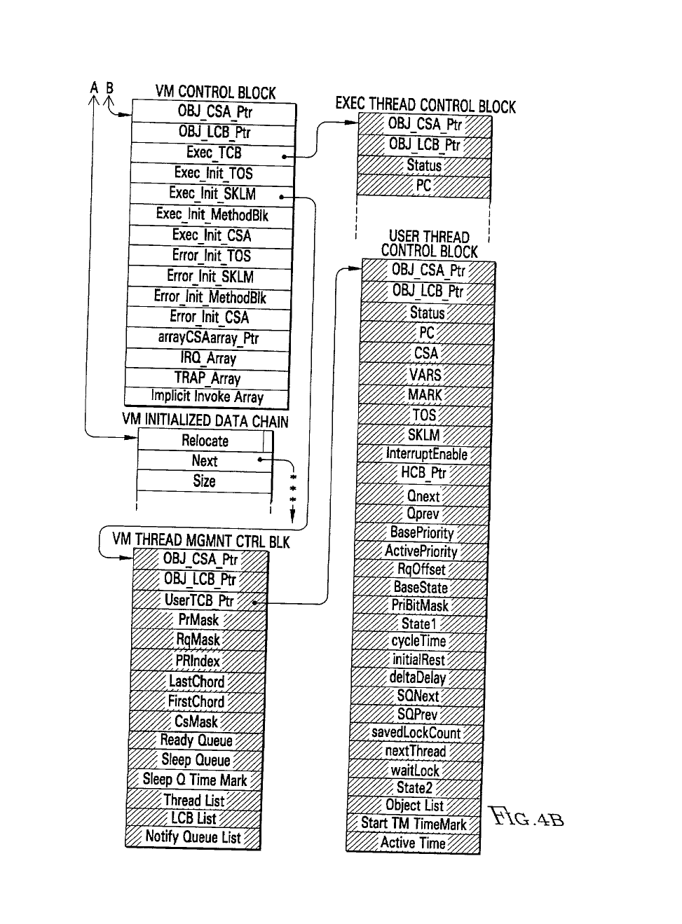

The organization of the various structures as implemented in the present embodiment is depicted in FIGS. 4A and 4B. The shaded blocks reside in random access memory (RAM) only, whereas the unshaded blocks can reside in RAM or in read only memory (ROM). The data structures above the dashed line 400 are considered privileged and should not be directly accessible by any virtual machine. The data structures below the dashed line 400 are intended to be accessible only by the virtual machine corresponding thereto. This confinement is enforced by the processor hardware and by the memory protection data structures in the virtual machine control elements.

The multipartitioned system of this embodiment provides support for three separate virtual machine schedules (only one of which is depicted in FIG. 4A).

The cold start schedule, associated with the Cold_JCE_List field 402 of the initialization table 404, provides the schedule to follow after a system reset. The warm restart schedule, associated with the Warm_JCE_List field 406 of the initialization table 404, provides the schedule to follow when power is restored after a power down. The warm start schedule typically feeds back into the cold start schedule. The power down schedule, associated with the PD_JCE_List field 408 of the initialization table 404, is used to schedule those partitions requiring notification of an imminent power failure. The power down schedule should be null terminated, allowing the processor to halt prior to actual power loss.

The back links 409 in the schedules are used to provide efficient insertion and deletion of partitions. Manipulation of the schedules by the runtime system software requires that careful attention be paid when assigning the back links in a schedule including only a portion of the partitions in the cycle. The back links are not used by the microcoded executive.

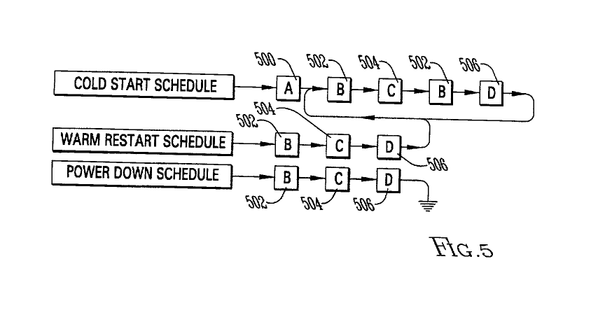

FIG. 5 depicts an embodiment having four partitions. Each partition has one or more virtual machine control elements included in one or more of the schedules. Virtual machine “A” 500 handles any necessary hardware initialization. Virtual machines “B” 502, “C” 504 and “D” 506 are scheduled during steady-state operation with virtual machine “B” 502 being activated more frequently than virtual machine “C” 504 and “D” 506. Other embodiments may employ different numbers and ordering of partitions, as well as different a number of virtual machine schedules, than is depicted in FIG. 5.

Referring again to FIG. 4, the initialization table 404 of this embodiment is fixed at location zero in the trusted address space. The fields in the initialization table 404 includes the following fields:

1) HW_Setup 410 locates any processor specific setup data. This field may be null if not required by a specific processor implementation.

2) HW_Store 412 locates the hardware data storage block in RAM.

3) Cold_JCE_List 402 locates the head of the virtual machine control element doubly-linked list (that may be circular as depicted) to be used on cold starts. Each partition in the system is represented by one or more control elements in the linked list. The order of the control elements represents the partition schedule.

4) Warm_JCE_List 406 locates the head of the virtual machine control element doubly-linked list to be used for scheduling on warm restarts. This schedule indicates the schedule and timing to be used during a warm restart of the processor. Typically, the last control element in the list feeds back into the cold start list.

5) PD_JCE_List 408 locates the head of the virtual machine control element doubly-linked list to be used during a power down. This list should be noncyclic and it should be terminated with a null Next pointer.

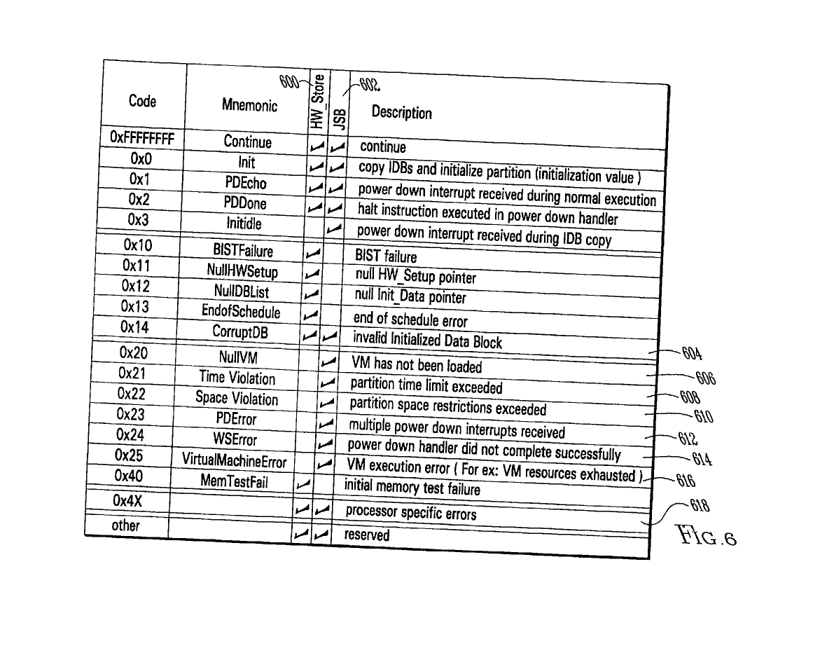

The processor specific data elements consist of two blocks. The hardware setup block 416 is typically located in ROM and may contain any processor specific setup information necessary to initialize the processor. For example, if the processor executes a built-in self test (BIST) following reset, the expected BIST signature can be read from this data block. The hardware store block 418, located in RAM, includes a first field 420 containing a status code as well as processor-specific data storage 422. The first field stores a system-level halt code. Valid halt codes for this embodiment are depicted in FIG. 6 as indicated by the check marks appearing under the HW-Store heading 600. Other embodiments can include greater or fewer halt codes than are depicted in FIG. 6.

The valid halt codes for the status field 424 of the virtual machine state block 426 are indicated by the check marks appearing under the JSB heading 602 in FIG. 6. In this embodiment, it is the status field 424 of the virtual machine state block 426 that is read (206, FIG. 2; 306, FIG. 3) to determine whether the next virtual machine control element is idle. The codes indicating that a virtual machine is idle are the various error codes 604, 606, 608, 610, 612, 614, 616, 618 listed in FIG. 6. Thus, the steps of either of the methods described in relation to FIGS. 2 and 3 can be performed within the context of FIGS. 4A and 4B.

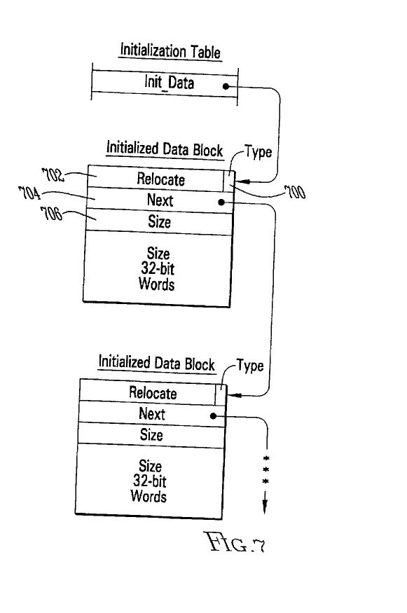

The Init-Data field 414 in the initialization table 404 locates a linked list of system-level initialized data blocks (IDBs) (not shown in FIG. 4A). In this embodiment, each IDB contains a block descriptor of three words and the initialized data as depicted in FIG. 7. The block descriptor contains the following fields:

1) Type 700 is a 2-bit field that identifies the type of the IDB (“00” indicates a ROM data block that does not get copied to RAM, “01” indicates a RAM data block that gets copied to RAM starting at address Relocate, “10” indicates a RAM zero block wherein Size words are filled with zero starting at address Relocate, and “11” indicates an invalid IDB type).

2) Relocate 702 identifies the absolute byte address where the data is to be located.

3) Next 704 identifies the next IDB in the list. Next is null in the last block of the list.

4) Size 706 identifies the number of 32-bit words in the data block (excluding the block descriptor).

The IDB list alleviates the chicken and egg problem for data initialization. The IDB list is typically created by the linker and supports two system configurations:

1A system with RAM only. The linker generated memory image is saved in external storage. This data must be loaded into memory prior to processor reset. The linker need not generate IDBs since data already resides in RAM and need not be copied.

2) A system with ROM and RAM. The linker generated memory image is set in ROM. The Relocate pointers identify addresses in RAM. The initialized data is copied from the ROM block to a RAM block. This initialized data in RAM may be used and manipulated by the program. The pointers to fields in blocks that are relocated must point to the RAM address.

It is thought that the method and apparatus of the present invention will be understood from the description provided throughout this specification and the appended claims, and that it will be apparent that various changes may be made in the form, construct steps and arrangement of the parts and steps thereof, without departing from the spirit and scope of the invention or sacrificing all of their material advantages. The forms herein described are merely representative embodiments thereof. For example, although some embodiments of the invention have been described in relation to JAVA virtual machines, the present inventions are capable of being used with other types of virtual machines that have been, or will be, developed. Further, it will be appreciated that a variety of different programming languages are available and appropriate for creating the code for the various embodiments.

1] a method, comprising the steps of:
establishing a plurality of virtual machines;
establishing a plurality of partitions of processor time;
assigning each virtual machine of the plurality of virtual machines to a partition of the plurality of partitions;
running, on a single processor, each virtual machine during its assigned partition; and
determining whether a virtual machine has any action to perform during its assigned partition and will thus be inactive during its assigned partition.

2] The method of claim 1, wherein at least one virtual machine of the plurality of virtual machines comprises a JAVA virtual machine.

3] The method of claim 1, wherein the plurality of virtual machines comprises a plurality of JAVA virtual machines.

4] The method of claim 1, wherein said assigning step takes into account results of prior determining steps in making assignments of virtual machines to partitions.

5] The method of claim 1, further comprising the step of establishing a plurality of partitions of processor memory.

6] The method of claim 1, further comprising the step of placing the single processor into a reduced power mode during a partition assigned to a virtual machine that has been determined to be inactive by said determining step.

7] The method of claim 6, wherein at least one virtual machine of the plurality of virtual machines comprises a JAVA virtual machine.

8] The method of claim 6, wherein the plurality of virtual machines comprises a plurality of JAVA virtual machines.

9] The method of claim 6, wherein the reduced power mode is terminated at the end of the partition assigned to the inactive virtual machine.

10] The method of claim 1, further comprising the step of reassigning, to another virtual machine, a partition previously assigned to a virtual machine that has been determined to be inactive by said determining step.

11] The method according to claim 10, wherein said reassigning step assigns a partition associated with an inactive virtual machine to the virtual machine assigned to the next partition.

12] The method according to claim 10, wherein said reassigning step assigns a partition associated with an inactive virtual machine to the next occurring partition that has been assigned to a virtual machine determined not to be inactive.

13] A computing apparatus, comprising:
a memory component storing code establishing a plurality of virtual machines, establishing a plurality of partitions of processor time, assigning each virtual machine of the plurality of virtual machines to a specific partition of the plurality of partitions, and determining whether a virtual machine has any action to perform during its assigned partition and will thus be inactive during its assigned partition;
a processor, coupled with said memory component, said processor being capable of running each virtual machine during its assigned partition and of running code stored on said memory component; and
wherein said memory component also stores code placing said processor into a lower power mode during a partition assigned to an inactive virtual machine.

14] The apparatus according to claim 13, wherein said processor comprises an embedded, low power processor.

15] The apparatus according to claim 13 wherein said processor comprises a JAVA processor.

16] The apparatus according to claim 13, wherein said processor comprises an embedded, low power JAVA processor.

17] The apparatus according to claim 13, wherein said processor comprises an aJ-80 processor.

18] The apparatus according to claim 13, wherein said processor comprises an aJ-100 processor.

19] A computing apparatus, comprising:
a memory component storing code establishing a plurality of virtual machines, establishing a plurality of partitions of processor time, assigning each virtual machine of the plurality of virtual machines to a specific partition of the plurality of partitions, and determining whether a virtual machine will be inactive during its assigned partition;
a processor, coupled with said memory component, to run each virtual machine during its assigned partition and to run code stored on said memory component; and
wherein said memory component also stores code activating a subsequent virtual machine during a partition assigned to an inactive virtual machine.

20] A computing apparatus, comprising:
means for storing code establishing a plurality of virtual machines, establishing a plurality of partitions of processor time, assigning each virtual machine of the plurality of virtual machines to a specific partition of the plurality of partitions, and determining whether a virtual machine has any action to perform during its assigned partition;
means for processing, coupled with said means for storing, said means for processing running each virtual machine during its assigned partition and running code stored on said means for storing; and
wherein said means for storing also stores code placing said means for processing into a reduced power mode for the duration of a partition that has been determined to have an inactive virtual machine.

21] A computing apparatus, comprising:
means for storing code establishing a plurality of virtual machines, establishing a plurality of partitions of processor time, assigning each virtual machine of the plurality of virtual machines to a specific partition of the plurality of partitions, and determining whether a virtual machine has any action to perform during its assigned partition;
means for processing, coupled with said means for storing, said means for processing running each virtual machine during its assigned partition and running code stored on said means for storing; and
wherein said means for storing also stores code reassigning, to another virtual machine, a partition previously assigned to a virtual machine that has been determined to be inactive.

22] A computer-readable storage medium, comprising:
a computer-executable code for establishing a plurality of virtual machines, establishing a plurality of partitions of processor time, assigning each virtual machine of the plurality of virtual machines to a specific partition of the plurality of partitions, determining whether a virtual machine will be inactive during its assigned partition, and for activating a subsequently scheduled virtual machine for the duration of a partition that has been determined to have an inactive virtual machine.

23] A computer-readable storage medium, comprising:
a computer-executable code for establishing a plurality of virtual machines, establishing a plurality of partitions of processor time, assigning each virtual machine of the plurality of virtual machines to a specific partition of the plurality of partitions, determining whether a virtual machine will be inactive during its assigned partition, and for activating a reduced power mode for the duration of a partition that has been determined to have an inactive virtual machine.

24] A computer-readable storage medium, comprising:
a computer-executable code to establish a virtual machine schedule for activating a plurality of virtual machines, to determine whether a scheduled virtual machine will be inactive during its scheduled activation time, and to initiate a reduced power mode for the duration of an inactive virtual machine's scheduled activation time.

25] A computer-readable storage medium, comprising:
a computer-executable code to establish a virtual machine schedule for activating a plurality of virtual machines, to determine whether a scheduled virtual machine will be inactive during its scheduled activation time, and to initiate reassignment, to another virtual machine, of a partition previously assigned to a virtual machine that has been determined to be inactive.

26] A method, comprising the steps of:
establishing a virtual machine schedule for activating, on a single processor, a plurality of virtual machines;
determining whether a scheduled virtual machine will be inactive during its scheduled activation time; and
initiating processor entry of a reduced power mode for the duration of an inactive virtual machine's scheduled activation time.

27] A method, comprising the steps of:
establishing a virtual machine schedule for activating, on a single processor, a plurality of virtual machines;
determining whether a scheduled virtual machine will be inactive during its scheduled activation time; and
initiating reassignment of an inactive virtual machine's scheduled activation time to a virtual machine determined to be active.

28] A method, comprising the steps of:
establishing a plurality of JAVA virtual machines;
establishing a plurality of partitions of processor time;
assigning each JAVA virtual machine of the plurality of JAVA virtual machines to a partition of the plurality of partitions;
running, on a single embedded low power JAVA processor, each JAVA virtual machine during its assigned partition;
determining whether a JAVA virtual machine to be run has any action to perform during its assigned partition and will thus be inactive during its assigned partition;
placing the single embedded low power JAVA processor into a reduced power mode during a partition assigned to the JAVA virtual machine that has been determined to be inactive by said determining step; and
exiting the reduced power mode at the end of the partition assigned to the inactive JAVA virtual machine and placing the single embedded low power JAVA processor into a higher power mode.
